(19) United States
(12) Patent Application Publication
(10) Pub. No.: US 2002/0069285 A1
(43) Pub. Date: Jun. 6, 2002

(54) Establishing communication between a remote agent and an end-user

(76) Inventors: Michel Burger, Palo Alto, CA (US); Anne Hardy, Redwood City, CA (US)

Correspondence Address: Denis G. Maloney, Esq., Fish & Richardson P.C., 225 Franklin Street, Boston, MA, 02110-2804, US

(21) Appl. No.: 09/809,677

(22) Filed: Mar. 15, 2001

Related U.S. Application Data
(60) Provisional application No. 60/189,836, filed on Mar. 16, 2000.

(51) Int. Cl. G06F 15/16

(52) U.S. Cl. 709/228

(57) ABSTRACT

A network includes a client, a Web server in communication with the client, a media framework server in communication with the Web server, and communication servers capable of communicating with the client through modes of communication. The client specifies a mode of communication to the Web server. The Web server provides the mode of communication to the media framework server. The media framework server instructs a communication server that corresponds to the mode of communication to contact the client. The communication server contacts the client using the mode of communication.

### CLAIM TO PRIORITY

This application claims priority from U.S. Provisional Application No. 60/189,836, filed on Mar. 16, 2000, the contents of which are hereby incorporated by reference into this application as if set forth herein in full.

### TECHNICAL FIELD

This invention relates generally to establishing communication between a remote agent and an end-user, and, more particularly, to using a media framework server in establishing the communication.

### BACKGROUND OF THE INVENTION

Communications between an end-user and a remote agent are established via a communication server. Examples of communication servers include voice servers, online chat servers, video servers, and document-sharing servers.

In order to establish communication between the end-user and the remote agent, a connection is established between a client (e.g., the end-user's computer) and a communication server on a network. Heretofore, the end-user at the client was queried for contact information each time a connection was established between the client and a communication server. This arrangement required the end-user to provide the same information repeatedly, i.e., to each communication server for each new connection.

### SUMMARY

This invention provides a media framework server that is interposed between a Web server and a communication server. The Web server requests contact information once from an end-user. The contact information includes, e.g., an e-mail address, IP (Internet Protocol) address, and telephone number. The Web server provides that information to the media framework server. The media framework server stores the contact information for the end-user.

When the end-user wishes to communicate with a remote agent, e.g., at a remote server, the Web server selects the appropriate agent and sends a request to the media framework server. In response to this request, the media framework server retrieves the end-user's contact information and instructs an appropriate communication server to establish the connection between the remote agent and the end-user using the contact information.

By storing contact information for the end-user, the media framework server facilitates connections between remote agents and end-users. That is, the media framework server reduces the need for the end-user to repeatedly provide the same contact information when establishing connections to remote agents.

In general, in one aspect, the invention is directed to establishing communication between a server and an end-user. This aspect of the invention features retrieving data that relates to the end-user, the data including a communication mode and contact information for establishing communication with the end-user, providing the contact information to a server that corresponds to the communication mode, and establishing communication to the end user, via the server, using the contact information. This aspect may also include one or more of the following features.

The identity of a remote agent may be received and communication may be established between the end-user and the remote agent via the communication mode. A user profile may be stored that contains the contact information. Retrieving the data may include retrieving the contact information from the user profile. The data may be retrieved from a server that is in communication with the end-user. The communication mode may include one of video, voice and online chat. The server may include one of a video server, a voice server, and an online chat server.

The contact information may be provided to the server via an application programming interface interfaced to the server. The contact information may include one or more of an Internet Protocol address, a telephone number, and an e-mail address. The end-user may be provided with a graphical user interface for selecting the mode of communication.

In general, in another aspect, the invention is directed to a network that features a client, a Web server in communication with the client, a media framework server in communication with the Web server, and communication servers capable of communicating with the client through modes of communication. The client specifies a mode of communication to the Web server. The Web server provides the mode of communication to the media framework server. The media framework server instructs a communication server that corresponds to the mode of communication to contact the client. The communication server contacts the client using the mode of communication. This aspect of the invention may include one or more of the following features.

The Web server may provide contact information for an end-user at the client to the media framework server. The communication server may use the contact information to contact the client. The media framework server may store the contact information in a profile for the end-user. The contact information may include one or more of an Internet Protocol address, a telephone number, and an e-mail address. The Web server and the media framework server may be implemented on the same machine. The Web server, the media framework server, and the communication servers may be implemented on the same machine.

This summary has been provided so that the nature of the invention can be understood quickly. A detailed description of illustrative embodiments of the invention is set forth below.

### DESCRIPTION OF THE DRAWINGS

FIG. 1 is a block diagram of a network.

FIG. 2 is a flowchart showing a process for connecting an end-user to a remote agent on the network.

### DESCRIPTION

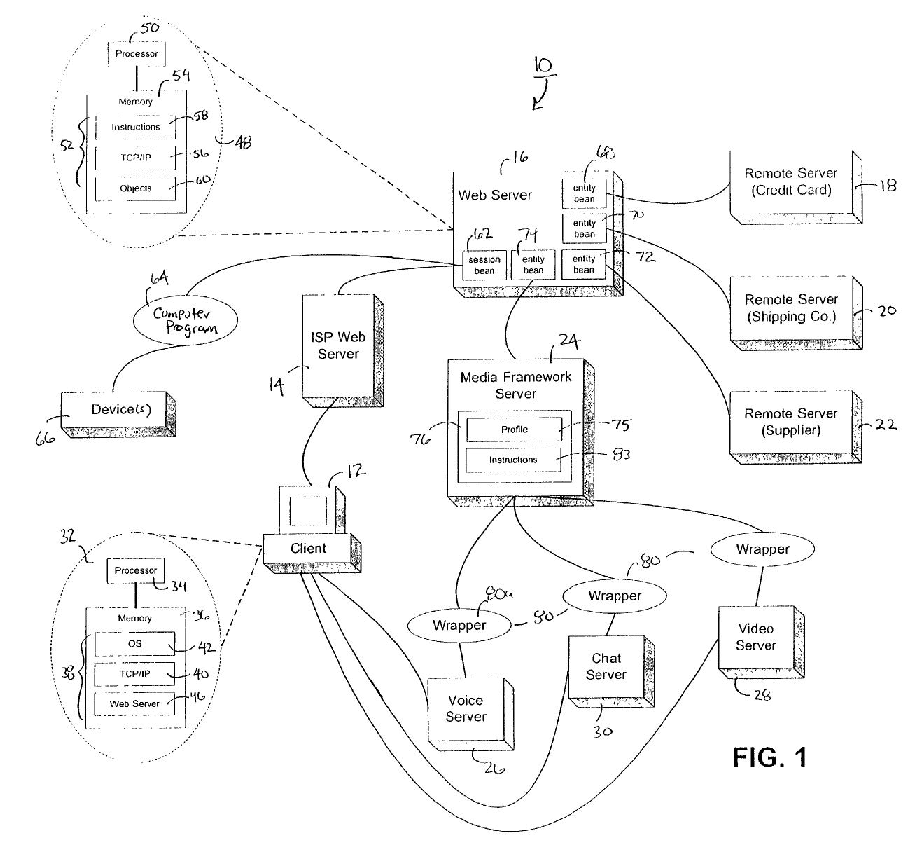

FIG. 1 shows a network 10. Network 10 contains a client 12, Web servers 14 and 16, remote servers 18, 20 and 22, media framework server 24, and communication servers 26, 28 and 30. The servers are computer programs that perform the functions described below. The servers can be run on the same computer or on separate computers. In this embodiment, each server is run on a separate computer. The word “server” is thus used to describe both a computer program and the machine running the computer program.

Network 10 is the Internet; however, network 10 can be any type of computer network, such as a local area network (LAN) or a wide area network (WAN). Devices on network 10 communicate via TCP/IP (Transmission Control Protocol/ Internet Protocol) or some other suitable network protocol.

Client 12 is a device, such as a computer; however, as noted below, client 12 may be any type of device that is capable of accessing the Internet. As shown in view 32, client 12 includes a processor 34 and a memory 36. Processor 34 executes the computer programs 38 stored in memory 36 to, among other things, access network 10. Programs 38 include a TCP/IP stack 40 for communicating over network 10, an operating system (OS) 42 such as Microsoft® Windows98®, and a Web browser 46, such as Microsoft® Internet Explorer® or Netscape® Navigator®. Using Web browser 46, an end-user at client 12 can access Web pages via network 10.

To access Web pages, client 12 connects to Web server 14, which is maintained by an ISP (Internet Service Provider), such as America Online® (AOL). ISP Web server 14 provides client 12 with access to network 10 by assigning client 12 a temporary IP address, through which data, such as Web pages, can be transferred to and from client 12. Such Web pages may be provided from another Web server 16 connected to the ISP's Web server 16. For the example described below, it is assumed that Web server 16 is maintained by an electronic commerce (e-commerce) company that sells products over network 10.

As shown in view 48, Web server 16 contains processor 50, which executes computer programs 52 stored in memory 54 to perform various functions. Among the computer programs 52 are a TCP/IP protocol stack 56 for communicating over network 10 and instructions 58 for generating and serving Web pages. Computer programs 52 also include objects 60, referred to herein as “beans”, which act as software interfaces to other devices, e.g., servers or clients, on network 10.

Session bean 62 provides a connection to ISP Web server 14. As shown in FIG. 1, session bean 62 also connects to a computer program 64 that allows other devices 66 that do not support Web browsers, such as cellular telephones, to access network 10. Session beans are temporary in that they last as long as communications last between servers.

Entity beans, on the other hand, provide more permanent connections to other servers on the Internet. Entity beans 68, 70 and 72 connect to remote servers 18, 20 and 22, respectively. In the e-commerce example described below, each of remote servers 18, 20 and 22 is a computer or other device that controls various aspects of an e-commerce transaction. That is, remote server 18 is owned by a credit card company, remote server 20 is owned by a shipping company, and remote server 22 is owned by a supplier. Remote servers 18, 20 and 22 allow remote agents, such as customer service representatives, of companies that maintain the remote servers to communicate over network 10 (and thus to the end-user).

Entity bean 74 connects to media framework server 24. Media framework server 24 provides an interface between Web server 16 and various communications servers 26, 28 and 30. Media framework server 24 receives, through ISP Web server 14 and Web server 16, contact information for the end-user at client 12, along with the end-user's desired mode of communication and the identity of a remote agent with whom the end-user would like to communicate.

The contact information may be stored in a profile 75 in a memory 76 of media framework server 24. Alternatively, the contact information may be stored in a profile in memory 54 of Web server 16. When the end-user first connects to Web server 16 and, e.g., places an order, the end-user is prompted to input contact information, such as an electronic mail (e-mail) address, IP address, telephone number, mailing address, or the like. This information is maintained in a profile for the end-user. As noted, the profile may be stored in media framework server 24 (or Web server 16), and is used to set-up communications between an agent at a remote server 26, 28, 30 and the end-user using a desired mode of communication.

In this regard, Web server 16 provides the end-user with a graphical user interface (GUI) (not shown) along with its Web pages. Web server 16 generates this GUI based on the communication servers 26, 28 and 30 that are in communication with media framework server 24. Media framework server 24 informs Web server of the communication servers that it is in communication with and, thus, of the means of communication available between the end-user and the remote servers.

Examples of communication servers include a voice communication server (voice server) 26 for providing audio communications, an online chat communication server (chat server) 30 for providing text/written communications, and a video communication server (video server) 28 for providing video communications. Other communication servers, such as an electronic mail (e-mail) communication server may also be in communication with media framework server 24.

Instructions 58 in Web server 16 generate the GUI based on the means of communication available to media framework server 24. That is, if media framework server 24 is in communication with a voice server and a video server, the GUI provides voice and video options to the end-user. The end-user can thus select the mode of communication that the end-user prefers for communicating with a remote agent.

Media framework server 24 communicates with communication servers 26, 28, 30 through one or more intermediary computer programs 80, referred to herein as “wrappers”. In this embodiment, wrappers are JAVA-APIs (Application Programming Interfaces). Wrappers may be run on the same machine as their corresponding communication servers and/or on the same machine as media framework server 24. Wrappers provide any data translations needed between client 12 and a remote server. For example, wrapper 80a provides the services necessary to implement, e.g., a telephone connection between the end-user and a remote agent, e.g., a customer service representative, via a remote server. Voice server 26 may also provide any necessary connections to the PSTN (Public Switched Telecommunications/ Telephone Network) and/or a PBX (Private Branch Exchange) private telephone switchboard maintained by the owner of a remote server being contacted.

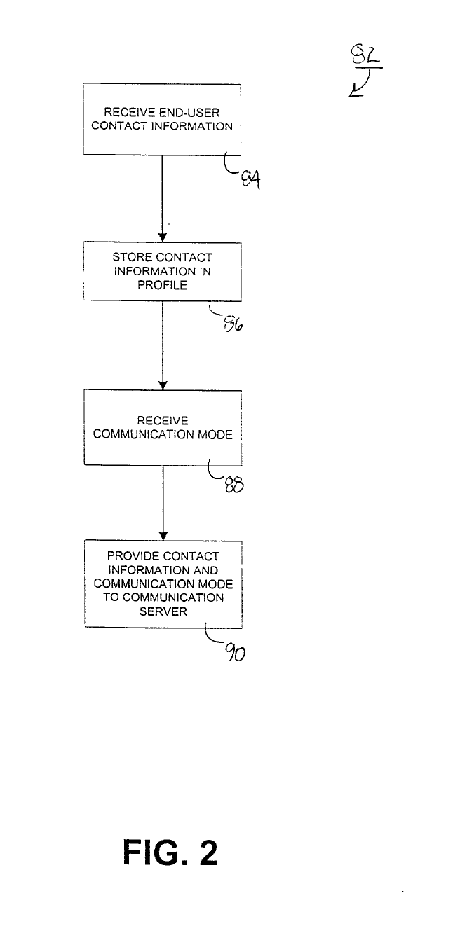

Referring to FIG. 2, a process 82 is shown for establishing communication between an end-user at client 12 and a remote agent via a remote server 18, 20 and/or 22. Process 82 may be performed to establish communication via any one or more of the communication modes available through communications servers 26, 28, 30. Because media framework server 24 stores a profile for the end-user that contains the end-user's contact information, the end-user need only input that information once, i.e., when the profile is set up. Thereafter, media framework server 24 can use the contact information in the end-user's profile to establish communication in the appropriate communication mode.

Process 82 is performed by instructions 83 that are part of media framework server 24. Process 82 receives (84), from Web server 16, data that relates to the end-user at client 12. The received data includes the contact information noted above, e.g., e-mail address, IP address, telephone number.

Process 82 may store (86) the contact information in a profile 75 on media framework server 24, which can be accessed in the future, or it may receive the contact information from a profile stored on Web server 16. In addition to the contact information, process 82 receives (88), also through Web server 16, a desired communication mode for the end-user, along with an agent whom the end-user wants to contact. The desired communication mode and the agent may be input by the end-user on a GUI provided to the end-user by Web server 16. The desired communication mode may be provided by the end-user each time the end-user wants to communicate with a remote agent or, alternatively, the desired communication mode may be input only once and stored in the end-user's profile.

Process 82 determines the end-user's desired mode of communication based on the information provided by Web server 16 (or from the end-user's profile). Based on the end-user's desired mode of communication, media framework server 24 is able to determine which communication server to contact. That is, if the end-user's desired mode of communication is voice, media framework server 24 contacts voice communication server 26. If the end-user's desired mode of communication is online chat, media framework server 24 contacts chat communications server 30, and so on. Media framework server 24 provides (90) the appropriate communication server with the appropriate contact information for the end-user.

By way of example, if an end-user's desired mode of communication is voice, media framework server 24 provides the end-user's telephone number to voice server 26. Voice server 26 uses that telephone number to connect to the end-user at client 12 and media framework server connects (through Web server 16) to a remote server that corresponds to the remote agent. Alternatively, voice server 26 may connect directly (i.e., not through Web server 16 and media framework server 24) to the remote server or an agent via the PSTN. Once connected, the end-user at client 12 communicates with the remote server via the end-user's desired mode of communication. Which remote server the end-user connects to depends on the agent or services the end-user wants.

An e-commerce transaction will now be described using process 82 and network 10. An end-user at client 12 links to a Web page output by Web server 16 through ISP Web server 14. Web server 16 maintains a business-to-business (B2B) site, which links the user to a supplier at remote server 22. Web server 16 is also linked to a remote server 18 that verifies credit card information and a remote server 20 that controls shipping of the product provided by the supplier. The Web page that the end-user is viewing (not shown) includes product, e.g., book selections. The user places an order through the Web page.

Upon placing the order, Web server 16 provides the user with a total cost. In response, the user inputs a credit card number onto the Web page. The credit card number is transferred to remote server 18, where it is verified. Upon verification, remote server 18 notifies Web server 16 that the credit card has been verified for the purchase price. Web server 16 orders the product from supplier 22 and pays supplier out of the money provided from the end-user. Web server 16 also engages a shipper, through remote server 20, to ship the product the end-user at the end-user's address.

At any point in the foregoing transaction, the end-user may wish to check on its status. For example, the end-user may wish to check whether the user's credit card cleared, whether the supplier has the product in stock, and/or whether the product is currently being shipped. To do this, the end-user logs onto a Web page provided by Web server 16 (not shown) and inputs, e.g., an order number that was provided when the product was initially purchased. The end-user also inputs the information to be checked, e.g., whether a credit card was approved, whether product is in stock, etc., along with the end-user's desired mode of communication, e.g., voice, online chat, video, etc. The desired mode of communication is input on a GUI provided with the Web page.

The foregoing information is transmitted to Web server 16 via ISP Web server 14. From there, the information is provided to media framework server 24. Media framework server 24 uses the information to connect the end-user to the appropriate agent at one of remote server 26, 28 or 30. The connection may be direct, i.e., the connection may be a direct connection from client 12, through a communication server, to a remote server. Alternatively, the connection may be through other hardware (not shown), such as the PSTN and a PBX. The connection may also be routed through Web server 16 and/or media framework server 24.

By way of example, the end-user may request the shipment status of an order placed through Web server 16. Also, the end-user may wish to receive the status information by telephone, i.e., voice. Media framework server 24 therefore receives (via ISP Web server 14 and Web server 16) information identifying the end-user and the end-user's desired communication mode (voice) and an indication that the end-user wants to receive a shipment status update.

Instructions 83 in media framework server 24 retrieve the contact information, in this case the end-user's telephone number, from a stored profile for the end-user. As noted, the profile may be stored on media framework server 24 or on Web server 16. Instructions 83 provide the contact information to the appropriate communication server 26 via wrapper 80a. In this case, the appropriate communication server is voice server 26. Voice server 26 uses the contact information to establish telephone contact to the end-user at client 12 and media framework server contacts the appropriate remote server, i.e., the server 20 owned by the shipping company. The voice server may be a PBX and voice data may be routed through the PSTN (not shown). Once the connection is established between the end-user and an appropriate agent at the shipping company, the end-user can check on the shipment status of the order. Substantially the same process is performed to check status using the other remote servers.

The system described herein is not limited to use with the hardware/software/GUI configurations of FIGS. 1 and 2; it may find applicability in any computing or processing environment. The system may be implemented in hardware, software, or a combination of the two (e.g., using an ASIC (Application-Specific Integrated Circuit) or programmable logic). The system may be implemented in one or more computer programs executing on programmable computers that each includes a processor, a storage medium readable by the processor (including volatile and non-volatile memory and/or storage elements), at least one input device, and one or more output devices. Program code may be applied to data entered to generate output information.

Each such program may be implemented in a high level procedural or object-oriented programming language to communicate with a computer system. However, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform implement the system. The system may also be implemented, at least in part, as a computer-readable storage medium, configured with a computer program, where, upon execution, instructions in the computer program cause a computer to operate appropriately.

The system is also not limited to using a computer as client 12. That is, any device, such as a cellular telephone or other hand-held device, can be used to access Web server 16. Connections to devices other than computers may be made through a software program 64, which performs any necessary data translations and the like that enable the Internet access device (e.g., cellular telephone) to communicate with Web server 16.

The system is not limited to using only those communication servers described above. Likewise, the system is not limited to use in e-commerce. It may be employed to connect any end-user to any remote server for whatever purpose. The system can also be implemented outside of an Internet/Web context with any type of network, wired, wireless, or otherwise.

Other embodiments not described herein are also within the scope of the following claims.

What is claimed is:

1. A method for use in establishing communication between a server and an end-user, the method comprising:
retrieving data that relates to the end-user, the data including a communication mode and contact information for establishing communication with the end-user;
providing the contact information to a server that corresponds to the communication mode; and
establishing communication to the end user, via the server, using the contact information.

2. The method of claim 1, further comprising receiving an identity of a remote agent;
wherein the communication is established between the end-user and the remote agent via the communication mode.

3. The method of claim 1, further comprising:
storing a user profile that contains the contact information;
wherein retrieving comprises retrieving the contact information from the user profile.

4. The method of claim 1, wherein the data is retrieved from a server that is in communication with the end-user.

5. The method of claim 1, wherein the communication mode comprises one of video, voice and online chat, and the server comprises one of a video server, a voice server, and an online chat server.

6. The method of claim 1, wherein the contact information is provided to the server through an application programming interface that interfaces to the server.

7. The method of claim 1, wherein the contact information comprises one or more of an Internet Protocol address, a telephone number, and an e-mail address.

8. The method of claim 1, further comprising:
providing the end-user with a graphical user interface for selecting the mode of communication.

9. A network comprising:
a client;
a Web server in communication with the client;
a media framework server in communication with the Web server; and
communication servers capable of communicating with the client through modes of communication;
wherein the client specifies a mode of communication to the Web server, the Web server provides the mode of communication to the media framework server, the media framework server instructs a communication server that corresponds to the mode of communication to contact the client, and the communication server contacts the client using the mode of communication.

10. The network of claim 9, wherein the Web server provides contact information for an end-user at the client to the media framework server, and the communication server uses the contact information to contact the client.

11. The network of claim 10, wherein the media framework server stores the contact information in a profile for the end-user.

12. The network of claim 11, wherein the contact information comprises one or more of an Internet Protocol address, a telephone number, and an e-mail address.

13. The network of claim 9, wherein the Web server and the media framework server are implemented on the same machine.

14. The network of claim 9, wherein the Web server, the media framework server, and the communication servers are implemented on the same machine.

15. A computer program stored on a computer-readable medium for use in establishing communication between a server and an end-user, the computer program comprising instructions that cause a machine to:
retrieve data that relates to the end-user, the data including a communication mode and contact information for establishing communication with the end-user;
provide the contact information to a server that corresponds to the communication mode; and
establish communication to the end user, via the server, using the contact information.

16. The computer program of claim 15, further comprising instructions that cause the machine to receive an identity of a remote agent;
wherein the communication is established between the end-user and the remote agent via the communication mode.

17. The computer program of claim 15, further comprising instructions that cause the machine to:
store a user profile that contains the contact information;
wherein retrieving comprises retrieving the contact information from the user profile.

18. The computer program of claim 15, wherein the data is retrieved from a server that is in communication with the end-user.

19. The computer program of claim 15, wherein the communication mode comprises one of video, voice and online chat, and the server comprises one of a video server, a voice server, and an online chat server.

20. The computer program of claim 15, wherein the contact information is provided to the server through an application programming interface that interfaces to the server.

21. The computer program of claim 15, wherein the contact information comprises one or more of an Internet Protocol address, a telephone number, and an e-mail address.

22. The computer program of claim 15, further comprising instructions that cause the machine to:
provide the end-user with a graphical user interface for selecting the mode of communication.

23. An apparatus for use in establishing communication between a server and an end-user, the apparatus comprising:
a memory that stores executable instructions; and
a processor that executes the instructions to:
retrieve data that relates to the end-user, the data including a communication mode and contact information for establishing communication with the end-user;
provide the contact information to a server that corresponds to the communication mode; and
establish communication to the end user, via the server, using the contact information.

24. The apparatus of claim 23, wherein:
the processor executes instructions to receive an identity of a remote agent; and
the communication is established between the end-user and the remote agent via the communication mode.

25. The apparatus of claim 23, wherein:
the processor executes instructions to store a user profile that contains the contact information; and
retrieving comprises retrieving the contact information from the user profile.

26. The apparatus of claim 23, wherein the data is retrieved from a server that is in communication with the end-user.

27. The apparatus of claim 23, wherein the communication mode comprises one of video, voice and online chat, and the server comprises one of a video server, a voice server, and an online chat server.

28. The apparatus of claim 23, wherein the contact information is provided to the server through an application programming interface that interfaces to the server.

29. The apparatus of claim 23, wherein the contact information comprises one or more of an Internet Protocol address, a telephone number, and an e-mail address.

30. The apparatus of claim 23, wherein the processor executes instructions to provide the end-user with a graphical user interface for selecting the mode of communication.
